(19) United States
(12) Patent Application Publication
(10) Pub. No.: US 2008/0309501 A1
(43) Pub. Date: Dec. 18, 2008

(54) Electronic System for Defence Against Fires in Forest Areas and More Generally for Monitoring the Territory

(76) Inventors: Alberto Redaelli, Milano (IT); Guido Moiraghi, Milano (IT); Tania Pozzi, Vigevano (IT); Luca Moiraghi, Milano (IT)

Correspondence Address: WENDEROTH, LIND & PONACK, L.L.P., 2033 K STREET N. W., SUITE 800, WASHINGTON, DC, 20006-1021, US

(21) Appl. No.: 11/659,233

(22) PCT Filed: Jul. 29, 2005
(86) PCT No.: PCT/EP2005/053719

§ 371 Date: Sep. 5, 2007

(30) Foreign Application Priority Data
Aug. 5, 2004 (IT) MI2004 A 001607

(51) Int. Cl. G08B 17/12

(52) U.S. Cl. 340/578; 340/577

(57) ABSTRACT

The invention refers to an electronic system for defence against fires in forest areas and more generally for monitoring the territory. The system comprises a network of alarm stations (SA) distributed over the territory being controlled, where each alarm station (SA) is enclosed in an air-scaled mechanically-sealed protective casing and comprises at least one sensor (S1-S3), a microcontroller (MC), a transceiver (RTX) at low power radiofrequency fitted with antenna (A) and a battery (B) for the electric powering of said sensor (S1-S3), said microcontroller (MC) and said transceiver (RTX). The alarm station network (SA) is in wireless communication with at least one intermediate detection unit (CIR) in turn in communication with at least one central control station (SC) controlled by bodies authorised to control and defend the territory.

The present invention refers to a low cost integrated system with low ecological impact for the defence against forest fires, and more generally for the environmental surveillance of the territory (temperature, CO, humidity, UV).

Currently the problem of forest fires has a heavy economic impact. The European Commission estimates that the cost of a hectare of burnt land, intended as expense needed for extinguishing the fire, is approximately 1000-5000 Euro.

Even though there are laws for the protection of the country's forest areas and for fire-prevention, innovative strategies for actuating these laws have not yet been fine-tuned. In particular there are no methods for early fire detection in forest areas in addition to those of active sighting.

Satellite tele-detection systems currently under study are aimed at mapping fire risk and land survey recording of the areas struck by fires and thus in danger of unauthorised building construction. The feasibility study in relation to their extension to early detection of fires is in progress, but these systems prefigure as extremely costly and extremely burdensome and complex in regard to image processing.

Alternative systems, mainly based on an architecture distributed on the territory, have been patented over the past few years, but they lack in fundamental merits such as low-cost, adaptability, low maintenance level and deterrence in relation to acts of vandalism. In particular systems based on video cameras are known that identify the fires by processing images and comparing them with previous images, such as EP-A-0818766, EP-A-0984413, U.S. Pat. No. 3,686,434 and WO-A-0197193, or based on a mixed sensor system (camera on mobile platform and infrared ray sensors), such as U.S. Pat. No. 5,734,335; they are generally costly systems, complex to produce and easily subject to acts of vandalism. Systems based on the monitoring of the area being inspected from an elevated position by means of laser technology or IR technology are also known, such as WO-A-03073128 and U.S. Pat. No. 5,218,345; however these systems are expensive to install, they need maintenance, they are heavily conditioned by the topography of the area and can easily be object of acts of vandalism. From U.S. Pat. No. 4,357,602 a system is also known that is based on a micro generator that absorbs energy from the fire, activates a radio frequency system and sends an alarm signal; its defects, which have probably affected the actual use, consist of the unavailability of an energy generator of that type and the low reliability, as it is not possible to carry out remote inspections to verify the functional state of the devices distributed over the territory. Finally, WO-A-04008407 describes in very general terms, without going into specific details, a system based on local devices capable of acquiring environmental data suitable for detecting temperature variations in the area concerned, a central control station comprising means for memorizing logistic and technical data relating to intervention means regarding the environment being monitored, transceivers for the exchange of data between local devices and the central station and means capable of processing the environmental data supplied by the local devices and the data contained in the processing means of the central control station to supply in output a model of evolution of the thermal front consequent to a critical thermal variation and an intervention plan to limit the resulting damages.

In view of this state of the art the object of the present invention is to produce an electronic system for defence against forest fires, and more generally for monitoring the territory, that uses low cost technology with low ecological impact, that is easy to install on the territory and can be adapted and configured according to different territorial configurations, that is extremely easy to produce and program, that has extremely low intervention, maintenance and logistic costs, that does not need technical verifications by state technical organisms, and that finally has characteristics that deter from criminal and vandalism acts.

In view of this object the present invention consists of a system of prevention and monitoring characterised in that it comprises a network of alarm stations distributed over the territory being controlled, where each alarm station is enclosed in a protective air-tight mechanically-sealed casing and comprises at least one sensor, a microcontroller, a low power radio frequency transceiver fitted with antenna and a battery for the electric powering of said sensor, said microcontroller and said transceiver, said alarm station network being in wireless communication with at least one intermediate detection unit in turn in communication with at least one central control station under the charge of bodies authorised to control and defend the territory.

An embodiment of the prevention and monitoring system according to the present invention is shown without any limiting intention in the enclosed drawings in which:

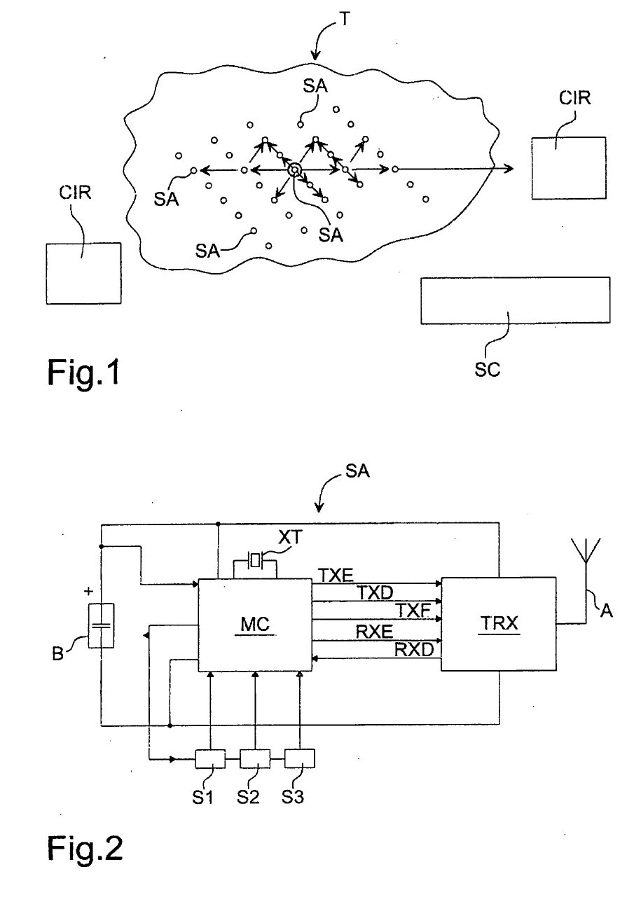

FIG. 1 shows the general structure of the system;

FIG. 2 shows a block diagram of an alarm station included in said system;

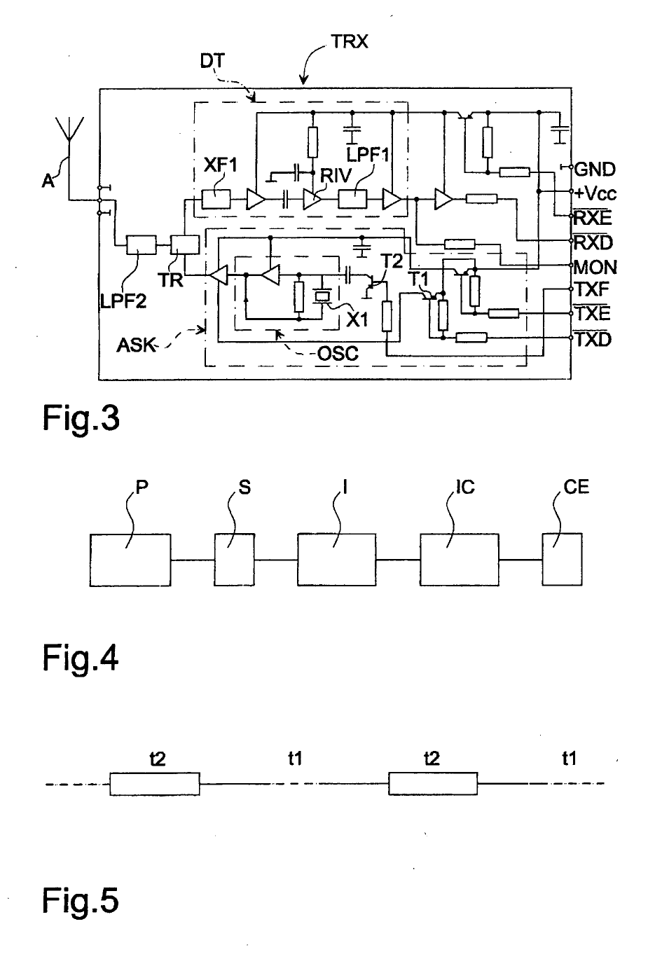

FIG. 3 shows the circuit diagram of a transceiver included in said alarm station;

FIG. 4 shows the conformation of the alarm signal emitted by said alarm station;

FIG. 5 represents schematically the type of timing of the alarm station;

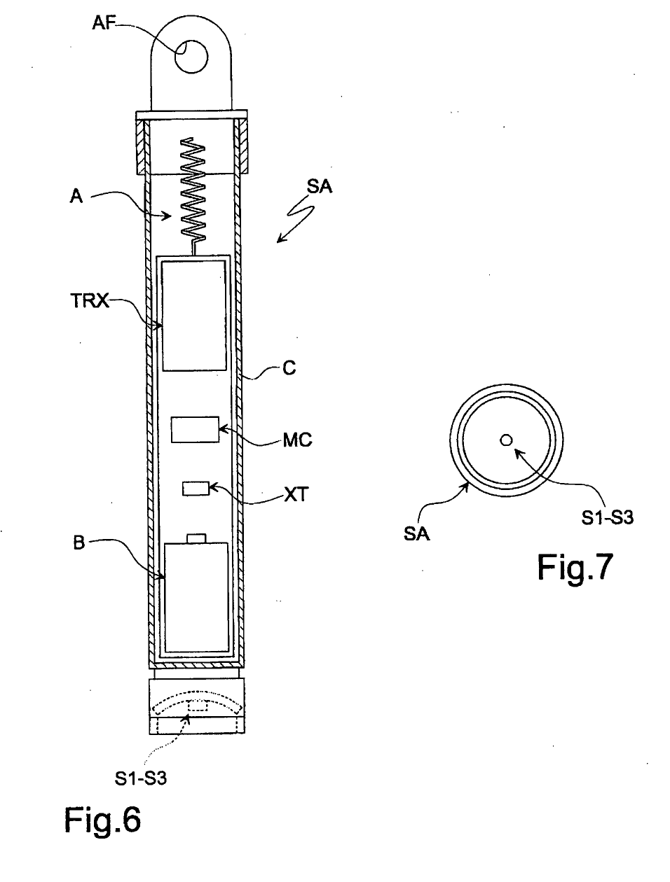

FIG. 6 shows in axial section an example of mechanical construction of an alarm station;

FIG. 7 shows the same example of alarm station seen from below.

FIG. 1 shows a network of alarm stations SA distributed at reciprocal distances substantially equal to each other within a territory T to be controlled in relation to forest fires or other events. The distance between the alarm stations can vary in function of the orographic diversities, the vegetation diversities and the degree of protection required. A variable distance between 30 and 150 metres is foreseen.

At least one intermediate detection unit CIR is located at the edges of the territory T with the task of detecting alarm signals emitted by the stations SA and transmitting relative information to a central control station SC by means of suitable earth and/or satellite communication systems.

An example of alarm station SA is shown in FIG. 2 and comprises at least one sensor, in the present case three, more precisely a temperature sensor S1, an infrared ray sensor S2 and a CO sensor S3. The sensors are activated by and communicate with a microcontroller MC with time base set by an extremely low consumption internal clock controlled by a quartz oscillator XT. The microcontroller MC communicates in turn with a low power radiofrequency transceiver TRX, fitted with antenna A. A battery B provides the electrical powering of the various components of the alarm station. The microcontroller controls the functioning of the alarm station, that is it controls the absorption of energy from the battery B, the system of sensors S1-S3, the sending and receiving of alarm signals through the transceiver TRX and, periodically, a system of supervision, control and maintenance of the alarm station.

An example of transceiver TRX is shown in FIG. 3 and comprises a transmitting part ASK fitted with an oscillator OSC with a resonator SAW (Surface Acoustic Wave) X1 at high stability with a transistor T1 for the amplitude modulation and a transistor T2 for the frequency modulation, a receiving part DT fitted with a detection stage RIV, a low-pass filter LPF1 and a filter SAW XF1, a selector TR between transmission and reception, and a further low-pass filter LPF2 placed between the selector TR and the antenna A.

The transceiver TRX receives from the microcontroller MC transmission enabling signals TXE, transmitted data signals TXD, frequency variation signals TXF and reception enabling signals RXE and sends received data signals RXD to the microcontroller.

In the functioning, by means of its internal clock, the microcontroller MC activates the sensors S1-S3 and the transceiver TRX for short activity periods (for example, 250 msec) alternated to longer rest periods t1 (for example, 10 sec) (FIG. 5). During the activity periods the alarm station is capable of acquiring any signals indicative of fire (high temperature gradient, presence of flame, high presence of CO), of sending alarm messages to the adjacent stations, of receiving alarm signals and re-transmitting them to the adjoining stations.

The alarm messages are of the type illustrated in FIG. 4, that is comprising a preamble P, whose task is to introduce the communication and establish the connection, a synchronism S, an address I, codified information IC relating to the alarm state and to the state of the battery B and finally an error control trailer CE.

Each alarm station is fitted with a univocal recognition or address number, that can be programmed when positioning the station itself and that is automatically associated to the emission of each alarm.

In case of alarm the station irradiates a message like that of FIG. 4 on a radio and low power channel for a time exceeding t1, so as to have the certainty that it overlays one of the times of activity t2 of all the adjacent stations and thus to have the certainty that they receive it, they verify its address as belonging to their network and they retransmit it, complete with the original address indicating the point of alarm, to those adjoining. The message thus is spread in all directions starting from the “alarmed” station (indicated with SA′ in FIG. 1) until it reaches one or more intermediate units CIR, which in turn transmit it (by means of telephone, radio, GSM or other) to the central control station. The average time for broadcasting an alarm will be statistically equal to t1/2×N, in which “W” is the number of stations situated between that detecting the fire and the unit CIR.

It is important to note that the alarm message is transmitted by radio frequency and low power. This enables operation in ISM bands where the norm of “free use” (“License Exempt”) is in force in accordance with the current norms RTT&E on the free use of short-range units.

The transmission is carried out with pulse amplitude modulation technique thanks to the transmitting part ASK.

The messages, both the original alarm and those retransmitted, are absolutely identical, both in contents of the message and time and duration of the pulses.

At the same time as the IC information relating to the alarm state, the signal of time synchronism S is also transmitted, that forces all the stations SA to retransmit the message in exactly coinciding times. Any collisions of signals (two or more) in a generic receiver are thus not a problem, but on the contrary are an advantage given that the single pulses constituting the messages are summed coherently. This synchrony does not lead to big difficulties in production because it must be kept only for the time needed for the broadcasting of the alarm. A time base made with a quartz oscillator of modest precision is adequate.

The problem of avoiding frequency beat between the radio frequency carriers of the various transmitters of the network is different. In fact they are “UHF” frequencies in the order of 900 MHz that do not permit (practically) the control of the frequency and the phase of the signal. If two carriers received by a receiver have a difference of frequency in the order of kHz between them, the beat generated in the detecting stage of the receiver can destroy the message. As it is foreseen to transmit the alarm messages at a speed of around 1 kbaud, the problem is resolved by generating in transmission the frequency of the carrier with the resonator SAW X1, that has a frequency accuracy of +/−150 kHz, and placing in the receiving part, after the detecting stage RIV, a low-pass filter LPF1 with cut-off frequency of about 5 kHz. The probability of frequency coincidence of two transceivers within 5 kHz is thus in the order of 3%.

To eliminate also this possibility the signal transmitted, in addition to being amplitude modulated by the alarm signal, is frequency modulated casually (with variation of about +/−10 kHz) by the signal TXF supplied by the microcontroller MC at the input of the transistor T.

FIGS. 6 and 7 finally show a possible mechanical structure illustrative of the alarm station SA, which inside an air-tight mechanically-sealed casing fitted with a fixing ring AF provides for the microcontroller MC, the quartz clock XT, the battery B (for example, a lithium battery), and the antenna A (for example, a helical antenna). In an end cavity of the container C, opposite the fixing ring AF, one or more sensors S1-S3 are positioned.

1. Electronic system for defense against fires in forest areas and more generally for monitoring the territory, characterised in that it comprises a network of alarm stations (SA) distributed over the territory being controlled, where each alarm station (SA) is enclosed in a protective air-tight mechanically-sealed casing and comprises at least one sensor (51-53), a microcontroller (MC), a transceiver (RTX) at low power radiofrequency fitted with antenna (A) and a battery (B) for the electrical powering of said sensor (S1-S3), said microcontroller (MC) and said transceiver (RTX), said alarm station network (SA) being in wireless communication with at least one intermediate detection unit (OR) in turn in communication with at least one central control station (SC) controlled by bodies authorized to control and defend the territory.

2. Electronic system according to claim 1, characterised in that said microcontroller (MC) by means of an internal clock acts on said sensors (S1-S3) and said transceiver (RTX) so as to alternate rest times (t1) with activity times (t2) of a shorter duration than said rest times (t1).

3. Electronic system according to claim 2, characterised in that at each detection by said sensors (51-53) said microcontroller (MC) commands said transceiver (RTX) to emit an alarm message of a longer duration than said rest times (t1).

4. Electronic system according to claim 3, characterised in that said alarm message comprises a preamble (P), a synchronism (5), a station address (I), codified alarm information (IC) and error control (CE).

5. Electronic system according to claim 3, characterised in that said microcontroller (MC) is programmed so as to command said transceiver (RTX) to re-emit an identical alarm message synchronized with that received each time said transceiver (RTX) receives an alarm message coming from an adjacent station (SA).

6. Electronic system according to claim 3, characterised in that said transceiver (RTX) includes a transmitting part (ASK) suitable for generating an amplitude modulated carrier by said alarm message and in addition randomly frequency modulated by said microcontroller (MC) and a receiving part (DT) including a detector (RIV) and a low-pass filter (LPF1) suitable for preventing beat between the carriers of two alarm messages received simultaneously by the same transceiver (RTX).

7. Electronic system according to claim 6, characterised in that said transmitting part (ASK) of the transceiver (RTX) includes a resonator SAW (Surface Acoustic Wave) for the generation of the frequency of said carrier.

8. Electronic system according to claim 1, characterised in that one of said sensors (S1-S3) is a temperature sensor (S1).

9. Electronic system according to claim 8, characterised in that one of said sensors (S1-S3) is an infrared ray sensor (S2).

10. Electronic system according to claim 8, characterised in that one of said sensors is a CO sensor (S3).

11. Electronic system according to claim 4, characterised in that said microcontroller (MC) is programmed so as to command said transceiver (RTX) to re-emit an identical alarm message synchronized with that received each time said transceiver (RTX) receives an alarm message coming from an adjacent station (SA).

12. Electronic system according to claim 4, characterised in that said transceiver (RTX) includes a transmitting part (ASK) suitable for generating an amplitude modulated carrier by said alarm message and in addition randomly frequency modulated by said microcontroller (MC) and a receiving part (DT) including a detector (RIV) and a low-pass filter (LPF1) suitable for preventing beat between the carriers of two alarm messages received simultaneously by the same transceiver (RTX).

13. Electronic system according to claim 5, characterised in that said transceiver (RTX) includes a transmitting part (ASK) suitable for generating an amplitude modulated carrier by said alarm message and in addition randomly frequency modulated by said microcontroller (MC) and a receiving part (DT) including a detector (RIV) and a low-pass filter (LPF1) suitable for preventing beat between the carriers of two alarm messages received simultaneously by the same transceiver (RTX).

14. Electronic system according to claim 11, characterised in that said transceiver (RTX) includes a transmitting part (ASK) suitable for generating an amplitude modulated carrier by said alarm message and in addition randomly frequency modulated by said microcontroller (MC) and a receiving part (DT) including a detector (RIV) and a low-pass filter (LPF1) suitable for preventing beat between the carriers of two alarm messages received simultaneously by the same transceiver (RTX).

15. Electronic system according to claim 12, characterised in that said transmitting part (ASK) of the transceiver (RTX) includes a resonator SAW (Surface Acoustic Wave) for the generation of the frequency of said carrier.

16. Electronic system according to claim 13, characterised in that said transmitting part (ASK) of the transceiver (RTX) includes a resonator SAW (Surface Acoustic Wave) for the generation of the frequency of said carrier.

17. Electronic system according to claim 14, characterised in that said transmitting part (ASK) of the transceiver (RTX) includes a resonator SAW (Surface Acoustic Wave) for the generation of the frequency of said carrier.

18. Electronic system according to claim 9, characterised in that one of said sensors is a CO sensor (S3).
